(19) United States
(12) Patent Application Publication
(10) Pub. No.: US 2026/0106501 A1
(43) Pub. Date: Apr. 16, 2026

(54) MOTOR FOR A STEERING SYSTEM OF A MOTOR VEHICLE AND STEERING SYSTEM FOR A MOTOR VEHICLE

(71) Applicants: thyssenkrupp Presta AG, Eschen (LI); thyssenkrupp AG, Essen (DE)

(72) Inventors: Tamas VALOVICS, Feldkirch (AT); Blaž BRATINA, Eschen (LI)

(73) Assignees: thyssenkrupp Presta AG, Eschen (LI); thyssenkrupp AG, Essen (DE)

(21) Appl. No.: 19/354,519

(22) Filed: Oct. 9, 2025

(30) Foreign Application Priority Data
Oct. 11, 2024 (BE) BE 2024/5676

(51) Int. Cl. H02K 1/278; H02K 1/14

(52) U.S. Cl. CPC H02K 1/278; H02K 1/146; H02K 2201/03; H02K 2213/03

(57) ABSTRACT

An electric motor for a steering system of a motor vehicle has a stator and a rotor mounted in the stator so as to be rotatable about a rotor axis. In such a motor, the number of stator teeth is 12 or a multiple of 12, the number of poles is 8 or a multiple of 8, the ratio of the magnet thickness to the magnet width is between 0.2 and 0.3, the ratio of the stator gap width to the stator tooth width is between 0.3 and 0.4, the ratio of the stator inner diameter to the stator outer diameter is between 0.45 and 0.55, the ratio of the stator inner diameter to the air gap width is between 45 and 55, the ratio of the magnet angle to the pole angle is between 0.85 and 0.95, the ratio of the magnet outer radius to the rotor diameter is between 0.2 and 0.3, and the ratio of the stator yoke thickness to the stator tooth width is between 0.65 and 0.75.

### CROSS REFERENCE TO RELATED APPLICATION

This application is a U.S. Non-Provisional that claims priority to Belgian Patent Application No. BE 2024/5676, filed Oct. 11, 2024, the entire content of which is incorporated herein by reference.

### FIELD

The present disclosure relates to an electric motor for a steering system of a motor vehicle.

### BACKGROUND

It is known to provide a driving torque by means of an electric motor in the steering system of a motor vehicle. For example, a motor can be used to generate an auxiliary torque in an EPAS (Electric Power Assisted Steering) steering system to support a manual steering input, or in a steer-by-wire steering system in a feedback actuator for generating a feedback torque, or in a steering actuator for generating a mechanical steering angle of steerable wheels.

The prior art has disclosed a large number of designs of motors for electric drives, which are mostly designed as universal motors having general use options in different applications. In particular in steering systems of motor vehicle systems, specific, particularly high demands are placed on the motorized drives used. For example, an ever-increasing power density and efficiency with the smallest possible dimensions and a low weight, and the highest degree of reliability and safety under adverse operating and environmental conditions over the entire service life of the vehicle are required.

The above-mentioned requirements can usually only be met to a limited extent with universal motors. It is therefore described in the prior art to provide motors for specific applications in steering systems, for example in US20090195104A1, U.S. Pat. No. 8,598,762B2 or 9,013,083B2.

The known motors are indeed already better adapted for use in steering systems. However, only specific properties are addressed in each case, and therefore optimization for a specific application in the steering system continues to be complicated.

Thus a need exists to enable improved use options and easier adaptation.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a steering system of a motor vehicle in a schematic perspective view.

FIG. 2 shows a perspective view of a motor according to the invention.

FIG. 3 shows a schematic cross section through the motor according to FIG. 2.

FIG. 4 shows a perspective view of a rotor according to the invention.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

The invention relates to an electric motor for a steering system of a motor vehicle, which has a stator and a rotor, which is mounted in the latter so as to be rotatable about a rotor axis,
the stator having a stator outer diameter and a stator inner diameter and comprising stator teeth which project radially inwards
and delimit the stator inner diameter, and
the number of which corresponds to a number of stator teeth, and
which each have a stator tooth width, and which are connected to each other externally via a stator yoke having a radial stator yoke thickness, and between each of which a stator gap having a stator gap width is formed, and which carry at least one stator winding, the rotor having a rotor diameter and magnets which are offset from each other over the outer circumference in each case at a pole angle and the number of which corresponds to a number of poles, and which extend parallel to the rotor axis, and which each have a magnet thickness in the radial direction and a magnet width in the circumferential direction, the magnet width extending over a magnet angle relative to the rotor axis, and the magnets are cylindrically curved coaxially to the rotor axis with a magnet outer radius, wherein an air gap having a radial air gap width is formed between the stator teeth and the magnets, and a steering system for a motor vehicle having such a motor is also the subject matter of the invention.

In the case of an electric motor for a steering system of a motor vehicle, which has a stator and a rotor, which is mounted in the latter so as to be rotatable about a rotor axis,
the stator having a stator outer diameter and a stator inner diameter and comprising stator teeth
which project radially inwards and delimit the stator inner diameter, and
the number of which corresponds to a number of stator teeth, and
which each have a stator tooth width, and
which are connected to each other externally via a stator yoke having a radial stator yoke thickness, and
between each of which a stator gap having a stator gap width is formed, and
which carry at least one stator winding,
the rotor having a rotor diameter and magnets which are offset from each other over the outer circumference in each case at a pole angle and
the number of which corresponds to a number of poles, and
which extend parallel to the rotor axis, and
which each have a magnet thickness in the radial direction and a magnet width in the circumferential direction, the magnet width extending over a magnet angle relative to the rotor axis, and
the magnets are cylindrically curved coaxially to the rotor axis with a magnet outer radius, wherein an air gap having a radial air gap width is formed between the stator teeth and the magnets,
it is provided according to the invention
that
   the number of stator teeth is 12 or a multiple of 12,
   the number of poles is 8 or a multiple of 8,
   the ratio of the magnet thickness to the magnet width is between 0.2 and 0.3,
   the ratio of the stator gap width to the stator tooth width is between 0.3 and 0.4,
   the ratio of the stator inner diameter to the stator outer diameter is between 0.45 and 0.55,
   the ratio of the stator inner diameter to the air gap width is between 45 and 55,
   the ratio of the magnet angle to the pole angle is between 0.85 and 0.95,
   the ratio of the magnet outer radius to the rotor diameter is between 0.2 and 0.3,
   the ratio of the stator yoke thickness to the stator tooth width is between 0.65 and 0.75.

The stator tooth width is measured in a radial section between the stator inner diameter and the stator outer diameter in the circumferential direction. The stator gap lies radially in the inner region, adjacent to the stator inner diameter. There, the stator tooth is widened in the circumferential direction relative to the stator tooth width. The number of stator gaps corresponds to the number of stator teeth. The number of stator teeth differs from the number of poles, which indicates the number of magnets in the form of permanent magnets distributed over the circumference of the rotor. The air gap width corresponds to half the difference between the stator inner diameter and the rotor diameter, which corresponds to the radius around the convexly outwardly curved magnets.

The stator gap width may also be synonymously referred to as a slot opening. In the prior art, the magnet angle is synonymously also referred to as the angle of inclination.

The magnets are in the form of permanent magnets, for example made of rare earth material or ferrite material. The magnetization may be oriented radially or axially in relation to the rotor axis.

The rotor basic body may be in the form of a stack of laminations consisting of a multiplicity of magnetic plates stacked in the axial direction, or may comprise such a stack of laminations.

According to the invention, a plurality of rotor parameters and stator parameters are defined for the rotor and the stator. Specifically, the rotor parameters comprise:
the number of stator teeth,
the ratio of magnet thickness MT/magnet width MW,
the ratio of magnet angle BetaM/pole angle BetaP,
the ratio of magnet outer radius RMO/rotor diameter D3/ROD
and the stator parameters comprise:
the number of poles,
the ratio of stator gap width SO/stator tooth width TW,
the ratio of magnet width MW/stator inner diameter D2,
the ratio of stator inner diameter D2/air gap width AG
the ratio of stator yoke thickness YT/stator tooth width TW.

The interaction thereof provides a fundamental basic optimization for use in a steering system. In contrast to the prior art, by which in each case only specific partial problems are addressed, the simultaneous optimization of which may lead to conflicts of objectives, according to the invention a comprehensive solution is provided for the first time. The individual adaptation to a specific steering system can be optimized by varying the rotor and stator parameters within the ranges defined according to the invention without obstructive conflicts of objectives with regard to specific requirements occurring.

An advantageous embodiment can be realized in that the ratio of the magnet thickness to the magnet width is 0.25. The magnets extend with their magnet width in the circumferential direction, and the magnet thickness corresponds to the radial dimension. This results in a substantially cuboidal basic shape, with the outer side being curved cylindrically outward.

It is advantageous that the ratio of the stator gap width to the stator tooth width is 0.34. The stator gap width is measured at the stator inner diameter in the circumferential direction in each case between adjacent stator teeth.

It is further advantageous that the ratio of the stator inner diameter to the stator outer diameter is 0.50. The stator inner diameter refers to the cylindrical axial passage which is delimited by the stator teeth protruding radially inward. The stator outer diameter is measured via the substantially hollow-cylindrical stator yoke, which encircles the entire circular circumference and connects the stator teeth mechanically and magnetically to each other.

It is furthermore advantageous that the ratio of the stator inner diameter to the air gap width is 51. The air gap refers to the gap clearance encircling in circular ring form in cross section between the rotor and the stator.

It is also advantageous that the ratio of the magnet angle (BetaM) to the pole angle (BetaP) is 0.89. The pole angle BetaP emerges from the total angle of 360° divided by the number of poles; in the case of eight poles correspondingly BetaP=45°. The magnet angle BetaM refers to the angular section relative to the rotor axis, which is occupied by a magnet. The fact that the magnet angle is always smaller than the pole angle BetaP means that the magnets are in each case spaced apart from each other in the circumferential direction, corresponding to the angular difference.

It is also advantageous that the ratio of the magnet outer radius to the rotor diameter is 0.26. The magnets are generically cylindrical on their radial outer side. The cylinder radius indicates the magnet outer radius. The rotor diameter is measured as the diameter of the radius around the radially furthest outwardly protruding vertices of the cylindrical outer sides.

It is also advantageous that the ratio of the stator yoke thickness to the stator tooth width is 0.68. As a result, the cross section of the stator yoke, which connects the stator teeth to each other along the outer circumference, is smaller than the cross section of a stator tooth.

It is furthermore advantageous that the stator winding is formed from a stator wire having a stator wire thickness, which is in a defined ratio to one of the above-mentioned stator parameters (D1, D2, TW, YT, SO).

It is advantageous that an electrical control unit is incorporated. The electrical control unit (ECU) can preferably form an integrated drive unit together with the motor. It comprises electrical supply and control circuits which are connected to the stator windings and which, in turn, interact with the electric steering control, for example interface circuits, safety devices, power output stages and the like. The integrated combination of the motor with the control unit is also known as a power pack. Owing to the design according to the invention of the motor, and the control unit design, which is adapted to the respective application, said power pack can be particularly compact and optimally coordinated with regard to the required electrical and mechanical characteristics.

The ECU can be integrated in a motor housing of the motor, which housing accommodates the stator, or in a control housing, which is connected to the motor housing. This means that a power pack having compact dimensions can always be provided.

An advantageous exemplary embodiment is given below, in which the stator and rotor parameters are realized within the ranges according to the invention.

| | Exemplary | Other |
|---|---|---|
| | embodiment | embodiment(s) |
| Stator gap width SO | 2.45 mm | |
| Stator tooth width SW | 7.3 mm | |
| Stator inner diameter D2 | 43 mm | |
| Stator outer diameter D1 | 86 mm | |
| Number of stator teeth NS | 12 | 12*n |
| Number of poles NP | 8 | 8*n |
| Magnet width MW | 13.45 mm | |
| Magnet thickness MT | 3.4 mm | |
| Ratio of magnet thickness | 0.25 | 0.20-0.30 |
| MT/magnet width MW | | |
| Air gap width AG | 0.85 mm | |
| Rotor diameter | 41.3 mm | |
| D3 = D2 − 2*AG = ROD | | |
| Ratio of stator gap width | 0.34 | 0.30-0.40 |
| SO/stator tooth width TW | | |
| Ratio of stator inner diameter | 0.5 | 0.45-0.55 |
| D2/stator outer diameter D1 | | |
| Ratio of magnet width | 0.31 | |
| MW/stator inner diameter D2 | | |
| Ratio of stator inner diameter | 50.59 | 45-55 |
| D2/air gap width AG | | |
| Magnet angle BetaM | 40.25° | |
| Magnet angle BetaM / pole | 0.89 | 0.85-0.95 |
| angle BetaP | | |
| Magnet outer radius RMO | 10.8 mm | |
| Ratio of magnet outer radius | 0.26 | 0.2-0.3 |
| RMO/rotor diameter D3/ROD | | |
| Ratio of stator yoke thickness | 0.68 | 0.65-0.75 |
| YT/stator tooth width TW | | |

The invention furthermore comprises a steering system for a motor vehicle, comprising at least one electric motor, characterized in that the motor is designed according to any one of the above-described embodiments or combinations thereof. The motor can be used in a power-assisted drive, or in a feedback actuator, and/or in a steering actuator.

It is advantageous that the rotor has fastening elements which are attached to a rotor basic body between the magnets and hold the magnets. The fastening elements protrude radially outwards. The rotor basic body may be formed in a manner known per se as an axial stack of laminations consisting of magnetic plates. The fastening elements can preferably be arranged from the rotor basic body in the intermediate space between two magnets which are adjacent in the circumferential direction. Accordingly, the width of the fastening elements, measured in the circumferential direction, is determined by the ratio according to the invention between the pole angle and the magnet angle which is smaller relative thereto. The fastening elements may simultaneously serve as spacers between the magnets in the circumferential direction and for fixing the magnets. A magnet is in each case positioned and fixed between fastening elements spaced apart in the circumferential direction. The fixing may be form-fitting, force-fitting and/or materially bonded.

It is preferred that the fastening elements have an axial length which is smaller than an axial magnet length of the magnets. Owing to the fact that the fastening elements, measured in the direction of the rotor axis, are shorter than the magnets, the magnet length being a multiple of the length of the fastening elements, there is an advantageous smaller influence on the magnetic field compared to known embodiments, in which the fastening elements extend over the entire magnet length or over a predominant part of the magnet length.

In the aforementioned embodiment, it may be provided that at least two fastening elements are spaced apart in the axial direction.

In the various figures, identical parts are always provided with the same reference signs, and will therefore generally also be named or mentioned only once in each case.

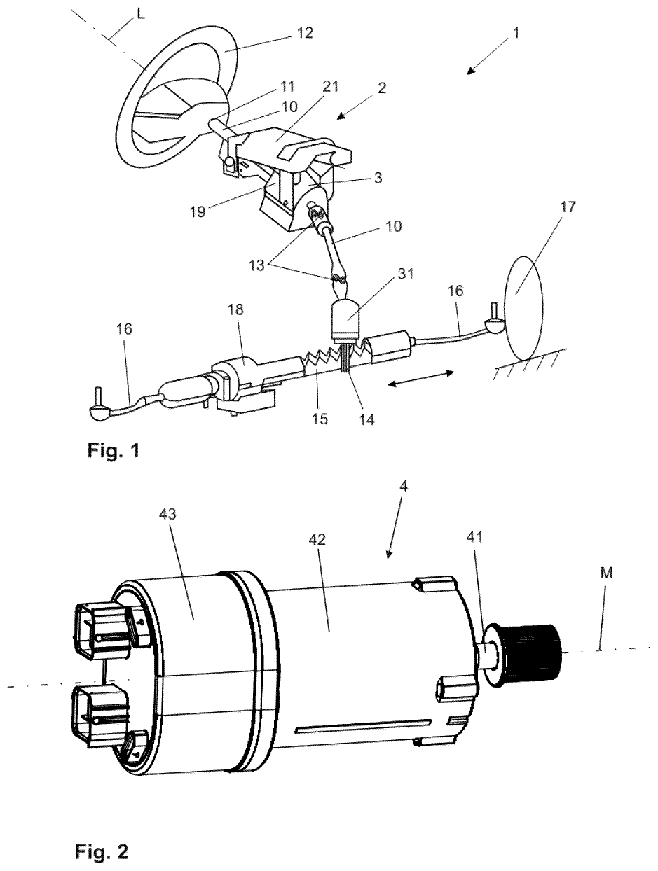

FIG. 1 schematically illustrates a motor vehicle steering system designed as an electromechanical auxiliary power steering system 1. The latter has a steering column 2 having a support unit 21, which is attachable to a motor vehicle body, not shown.

In the steering column 2, a steering spindle 10 is mounted so as to be rotatable about its longitudinal axis L. At its rear end with respect to the direction of travel, said steering spindle has a fastening section 11, to which a steering wheel 12 is attached for rotation therewith and via which a driver can introduce a steering torque (manual torque) as a steering command into the steering spindle 10.

The steering torque is transmitted via the steering spindle 10, which has universal joints 13 connected in between for adaptation to the installation position in the motor vehicle, to a steering pinion 14, which engages in a longitudinally displaceably mounted toothed rack 15. The latter converts rotation of the steering spindle 10, during a steering intervention, into a displacement of track rods 16, as indicated by the double arrow, which transmit the predetermined steering intervention as a steering angle to the steerable wheels 17 of the motor vehicle.

An electrical power-assisted support may comprise a power-assisted drive 3 which is attached to the steering column 2 and is coupled to the steering spindle 10, or a power-assisted drive 31 which is coupled with the steering spindle 10 to the pinion 14, the power-assisted drives 3 and 31 being able to be constructed identically. The power-assisted drive 3 or 31 allows an auxiliary torque to be coupled into the steering shaft 1 and/or the steering pinion 14 to assist the driver in the steering work.

A power-assisted drive 18 may also be provided in order to introduce an auxiliary force, which supports the steering system, into the toothed rack 15.

Normally, a power-assisted drive 3, 31 or 18 is attached only to one of the three positions shown. The auxiliary torque or the auxiliary force which is intended to be applied by the respective power-assisted drive 3, 31 or 18 in order to assist the driver is defined taking into consideration a steering torque which is determined by a torque sensor 19 and is manually introduced by the driver. Alternatively or in combination with the introduction of the auxiliary torque, an additional steering angle can be introduced into the steering system by the power-assisted drives 3, 31, 18, said additional steering angle being added to the steering angle applied by the driver via the steering wheel 12.

By means of the torque sensor 19, the manual torque introduced manually into the steering spindle 10 is detected, for example in a manner known per se, by measuring the torsion of a torsion rod integrated in the steering spindle 10. An auxiliary torque is determined via an electrical control unit, not shown, and an electrical control signal derived therefrom is fed into an electric motor 4 of the power-assisted drive 3, 31 or 18. The electromotive torque generated in this way is coupled into the steering spindle 10 via a transmission 5 of the electric power-assisted drive 3 to assist the manual steering work.

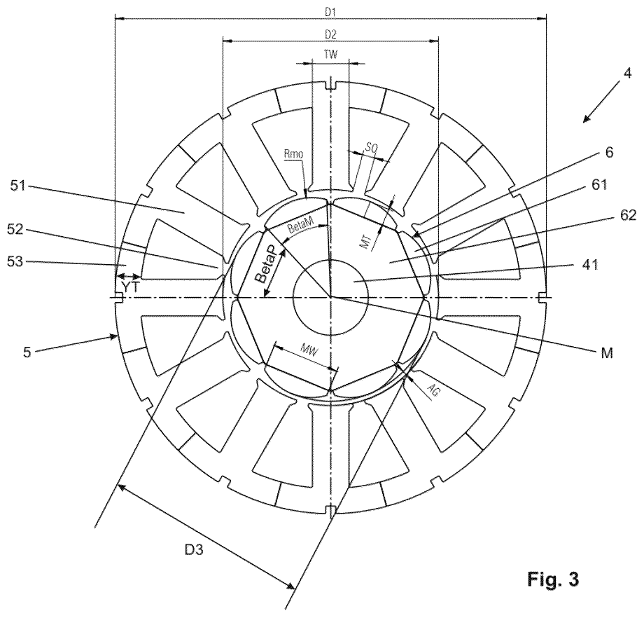

An electric motor 4 which is designed according to the invention and can be used in a power-assisted drive 3, 31 or 18 is shown detached in a perspective view in FIG. 2. Said motor has a motor shaft 41 which is rotationally drivable about the rotor axis M and is mounted in a motor housing 42. A control housing 43, in which can be accommodated an electrical control unit, not explicitly illustrated here, which is designed for the electrical activation of the motor 4, can be attached to said motor housing.

The motor 4 according to the invention is not limited to the use in a power-assisted drive 3, 31, or 18 according to FIG. 1, but can be advantageously also used elsewhere in a steering system, for example in a feedback actuator, in which the motor shaft 41 is coupled with the steering spindle 10. It is also conceivable and possible that a motor 4 according to the invention is used as a steering actuator in a steer-by-wire steering system, for example analogously to the power-assisted drive 31, or in a single-wheel steering actuator.

FIG. 3 shows a cross section through the motor 4 transversely to the rotor axis M. Said motor has a stator 5 and a rotor 6, which is mounted in the latter so as to be rotatable about a rotor axis M, the stator 5 having a stator outer diameter D1 and a stator inner diameter D2. The stator has stator teeth 51 which are uniformly distributed over the circumference, protrude radially inwards and delimit the stator inner diameter D2, and the number of which corresponds to a number of stator teeth NS=12. The stator teeth 51 have a stator tooth width TW, and are externally connected to each other via a stator yoke 53 with a radial stator yoke thickness YT.

Between each of the stator teeth 51, a stator gap 52 having a stator gap width SO is formed. In the region of its stator tooth width TW, each stator tooth 51 carries a stator winding, which is known in principle and is not shown here.

The rotor 6 has a rotor diameter D3 (=ROD) and magnets 61 which are offset from each other over the outer circumference in each case at a pole angle BetaP and, the number of which corresponds to a number of poles NP=8. The magnets 61 are in the form of permanent magnets and are fixed to a rotor basic body 62. They extend parallel to the rotor axis M, and each have a magnet thickness MT in the radial direction and a magnet width MW in the circumferential direction, the magnet width extending over a magnet angle BetaM relative to the rotor axis M.

The magnets 61 are cylindrically curved coaxially to the rotor axis M with a magnet outer radius RMO.

The magnet outer radius RMO is smaller than the radius of the rotor 6, which corresponds to half the rotor diameter D3.

An air gap having a radial air gap width AG is formed between the stator teeth 51 and the magnets 6.

The ratio of the magnet thickness MT to the magnet width MW is between 0.2 and 0.3, preferably 0.25.

The ratio of the stator gap width SO to the stator tooth width TW is between 0.3 and 0.4, preferably 0.34.

The ratio of the stator inner diameter D2 to the stator outer diameter D1 is between 0.45 and 0.55, preferably 0.50.

The ratio of the stator inner diameter D2 to the air gap width AG is between 45 and 55, preferably 50.59.

The ratio of the magnet angle BetaM to the pole angle BetaP is between 0.85 and 0.95, preferably 0.89.

The ratio of the magnet outer radius RMO to the rotor diameter D3 (ROD) is between 0.2 and 0.3, preferably 0.26.

The ratio of the stator yoke thickness YT to the stator tooth width TW is between 0.65 and 0.75, preferably 0.68.

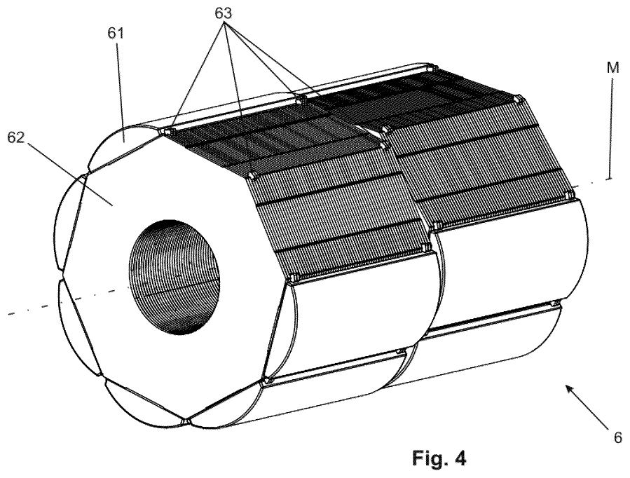

FIG. 4 shows a schematic perspective view of a rotor 6, which is formed from a multiplicity of magnetic plates stacked in the axial direction. In each case between two magnets 61 which are adjacent in the circumferential direction, two fastening elements 63 which are spaced apart in the axial direction are arranged, between which a magnet 61 is held in a form-fitting, force-fitting and/or materially bonded manner. The two magnets in the upper right quarter have been omitted in the illustration for better clarity. The fastening elements may be formed from the magnetic plates and protrude radially outwards from the rotor basic body 62. They have only a fraction of the magnet length, measured axially in the direction of rotor axis M.

### LIST OF REFERENCE SIGNS

1 Steering system (power-assisted steering system)
10 Steering spindle
11 Fastening section
12 Steering wheel
13 Universal joint
14 Steering pinion
15 Toothed rack
16 Track rod
17 Wheel
18 Power-assisted drive
19 Torque sensor
2 Steering column
21 Support unit
3, 31 Power-assisted drive
4 Motor
41 Motor shaft
42 Motor housing
43 Control housing
5 Stator
51 Stator tooth
52 Stator gap
53 Stator yoke
6 Rotor
61 Magnet
62 Rotor basic body
63 Fastening elements
L Longitudinal axis
M Rotor axis
D1 Stator outer diameter
D2 Stator inner diameter
NS Number of stator teeth
TW Stator tooth width
YT Stator yoke thickness
SO Stator gap width
D3 Rotor diameter (ROD)
BetaP Pole angle
NP Number of poles
MT Magnet thickness
MW Magnet width
BetaM Magnet angle (BetaM)
RMO Magnet outer radius (RMO)
AG Air gap width (AG)

1. An electric motor for a steering system of a motor vehicle, comprising:
a stator; and
a rotor mounted in the stator so as to be rotatable about a rotor axis;
the stator having a stator outer diameter and a stator inner diameter and including stator teeth which project radially inwards and delimit the stator inner diameter, and the number of which corresponds to a number of stator teeth, and which each have a stator tooth width, and which are connected to each other externally via a stator yoke having a radial stator yoke thickness, and between each of which a stator gap having a stator gap width is formed, and which carry at least one stator winding;
the rotor having a rotor diameter and magnets which are offset from each other over the outer circumference in each case at a pole angle and the number of which corresponds to a number of poles, and which extend parallel to the rotor axis, and which each have a magnet thickness in the radial direction and a magnet width in the circumferential direction, the magnet width extending over a magnet angle relative to the rotor axis, and the magnets are cylindrically curved with a magnet outer radius;
wherein an air gap having a radial air gap width is formed between the stator teeth and the magnets;
wherein the number of stator teeth is 12 or a multiple of 12;
wherein the number of poles is 8 or a multiple of 8;
wherein the ratio of the magnet thickness to the magnet width is between 0.2 and 0.3;
wherein the ratio of the stator gap width to the stator tooth width is between 0.3 and 0.4;
wherein the ratio of the stator inner diameter to the stator outer diameter is between 0.45 and 0.55;
wherein the ratio of the stator inner diameter to the air gap width is between 45 and 55;
wherein the ratio of the magnet angle to the pole angle is between 0.85 and 0.95;
wherein the ratio of the magnet outer radius to the rotor diameter is between 0.2 and 0.3;
wherein the ratio of the stator yoke thickness to the stator tooth width is between 0.65 and 0.75.

2. The electric motor according to claim 1, wherein the ratio of the magnet thickness to the magnet width is 0.25.

3. The electric motor according to claim 1, wherein the ratio of the stator gap width to the stator tooth width is 0.34.

4. The electric motor according to claim 1, wherein the ratio of the stator inner diameter to the stator outer diameter is 0.50.

5. The electric motor according to claim 1, wherein the ratio of the stator inner diameter to the air gap width is 51.

6. The electric motor according to claim 1, wherein the ratio of the magnet angle to the pole angle is 0.89.

7. The electric motor according to claim 1, wherein the ratio of the magnet outer radius to the rotor diameter is 0.26.

8. The electric motor according to claim 1, wherein the ratio of the stator yoke thickness to the stator tooth width is 0.68.

9. The electric motor according to claim 1, wherein the stator winding is formed from a stator wire having a stator wire thickness, which is at a defined ratio to one of the stator parameters.

10. The electric motor according to claim 1, further comprising an electrical control unit.

11. The electric motor according to claim 1, wherein the rotor has fastening elements, which are attached to a rotor basic body between the magnets and hold the magnets.

12. The electric motor according to claim 11, wherein the fastening elements protrude radially outwards.

13. The electric motor according to claim 11, wherein the fastening elements have an axial length which is smaller than an axial magnet length of the magnets.

14. The electric motor according to claim 13, wherein at least two fastening elements are spaced apart in the axial direction.

15. A steering system for a motor vehicle, comprising at least one electric motor according to claim 1.
